(19) United States
(12) Patent Application Publication
(10) Pub. No.: US 2022/0055339 A1
(43) Pub. Date: Feb. 24, 2022

(54) SOUND DAMPENING PAD

(71) Applicant: CHEW LONG DEVELOPING ENTERPRISE CO., LTD., Taichung City (TW)

(72) Inventor: Jing-Teng SHIH, Taichung City (TW)

(21) Appl. No.: 17/401,965

(22) Filed: Aug. 13, 2021

(30) Foreign Application Priority Data
Aug. 18, 2020 (TW) 109128095

(51) Int. Cl. B32B 5/24; B32B 5/02; B32B 5/18; G10K 11/168; E04F 15/20

(52) U.S. Cl. CPC B32B 5/245; B32B 5/022; B32B 5/024; B32B 2419/00; G10K 11/168; E04F 15/203; B32B 2307/102; B32B 5/18

(57) ABSTRACT

A construction sound dampening pad is provided to avoid pseudo-adhesive state. The construction sound dampening pad mainly has the following features: a foamed layer, made of rubber or polymer materials through a foaming process, and formed with first and second surfaces; first and second porous fiber layers, both being a porous layer structure containing fiber materials, and respectively bonded on the first surface of the foamed layer and the second surface; they are bonded together by attaching the first porous fiber layer to the first surface and attaching the second porous fiber layer to the second surface when the foamed layer is still not cooled and solidified during the process of melting and foaming, so as to form a structure wherein part of the structure of the first and the second porous fiber layers penetrates into the first and second surface to achieve a strong and reliable bonding.

### CROSS-REFERENCE TO RELATED U.S. APPLICATIONS

Not applicable.

### BACKGROUND OF THE INVENTION

### 1. Field of the Invention

The present invention relates generally to a construction sound dampening pad, and more particularly to an innovative design of a construction sound dampening pad structure to effectively avoid the problem of pseudo-adhesive state.

### 2. Description of Related Art Including Information Disclosed Under 37 CFR 1.97 and 37 CFR 1.98

Construction sound dampening pads (or anti-vibration pads) are mostly used as a floor structure for multi-story buildings. Some of them are also used as a separating wall structure. They are used to reduce and suppress noise and vibration. At present, as most people living in urban areas have neighbors on the same floor or on the next floor, it is important to use such building materials as sound dampening pads.

Common construction sound dampening pads are usually made of rubber pads. In actual implementations, when used as a floor structure, cement mortar is used to adhere it to the concrete floor. Because the surface of the rubber pad is not suitable for laying floor tiles, a cement mortar layer with thickness of at least 5 cm must be firstly applied on the surface of the rubber pad. Then, floor tiles are laid (usually by using tile gripper) on the cement mortar layer. In the above-mentioned structure, as the rubber pad itself is a hydrophobic material, it cannot be bonded perfectly with the cement mortar layer. Gaps may easily occur between the two materials. Such a condition is called “pseudo-adhesive” state in the industry. Over time, it will become easy for water or air to penetrate into the gaps, causing the cement mortar layer to have partial protrusions or deformations. It may even cause breakage of the floor tiles. In order to avoid this problem, a steel mesh is applied in the cement mortar layer structure to increase the structural strength of the cement mortar layer. However, this method also has drawbacks. The cement mortar layer must be at least 10 cm thicker to meet the construction engineering standard that each single mortar layer must be thicker than 5 cm to reach the minimum strength required. As a result, in order for the floor to have the sound-dampening function, the floor must be thickened for more than 10 cm. Otherwise, the aforementioned problems of partial protrusions and deformations may happen. And the water penetrating into the gaps may cause corrosion of the steel mesh, which consequently lead to less durability of the building structure. However, the aforementioned method only changes the position of the pseudo-adhesive state to another layer structure. The problem of pseudo-adhesive state is not fundamentally solved.

In the current construction industry, the conventional construction sound dampening pads are often criticized for the following problems: high engineering cost, low efficiency, added load of the floor (or separating wall) and less reliability of the structure. In short, the main problems in connection with the construction sound dampening pads can all be traced to the problem of pseudo-adhesive state between the sound dampening pad and the cement mortar layer, which causes unreliable bonding.

### BRIEF SUMMARY OF THE INVENTION

The main object of the present invention is to provide a construction sound dampening pad to avoid pseudo-adhesive state. It aims to make a breakthrough in solving the technical problems by developing an ideally practical new-style construction sound dampening pad.

In view of the above object, the invention solves problems through the following main technical features that the construction sound dampening pad includes: a foamed layer, in the form of a soft and flexible pad structure made of either rubber or polymer foamed in an appropriate proportion. The foamed layer having a thickness and having a first surface and a second surface. A first porous fiber layer is provided, being a soft, flexible, compressible, ductile, and porous layer structure containing fiber materials. The first porous fiber layer is attached to the first surface of the foamed layer. A second porous fiber layer is provided, being a soft, flexible, compressible, ductile, and porous layer structure containing fiber materials. The second porous fiber layer is attached to the second surface of the foamed layer. Specifically, the first porous fiber layer, the second porous fiber layer, and the foamed layer are bonded together by attaching the first porous fiber layer to the first surface, and attaching the second porous fiber layer to the second surface when the foamed layer is still not cooled and solidified during the process of melting and foaming, so as to form a structure wherein part of the structure of the first porous fiber layer penetrates into the first surface, and part of the structure of the second porous fiber layer penetrates into the second surface to achieve a strong and reliable bonding.

The main efficacy and advantage of the present invention is that, through the structural design that both sides of the foamed layer are reliably bonded with a porous fiber layer, in actual applications, the construction sound dampening pad can be firmly bonded with the concrete layer or floor tiles by simply using tile gripper or cement mortar. Because the porous fiber layer can realize an interlocking effect when the tile gripper or other cement mortar is hardened. Such an interlocked layer structure can effectively avoid the aforementioned problem of pseudo-adhesive state between the rubber pad and the cement mortar layer. Meanwhile, it can substantially reduce the engineering cost and time in applying cement mortar or laying a steel mesh. Therefore, the cost of construction sound-dampening structures is greatly reduced, the engineering efficiency can be greatly enhanced. Furthermore, through the present invention, the floor or wall structures can have less load and better reliability. It is a practical inventive step indeed.

### BRIEF DESCRIPTION OF THE SEVERAL VIEWS OF THE DRAWINGS

FIG. 1 is a perspective view of a preferred embodiment of a construction sound dampening pad according to the invention.

FIG. 2 is a partial sectional view in the 2-2 direction shown in FIG. 1.

FIG. 3 is a perspective view of a preferred embodiment of a construction sound dampening pad made into a roll for ready use.

FIG. 4 is a perspective view of a preferred embodiment of a construction sound dampening pad made into a stack for ready use.

FIG. 5 is a perspective sectional view of a preferred embodiment of the sound dampening floor according to the invention.

### DETAILED DESCRIPTION OF THE INVENTION

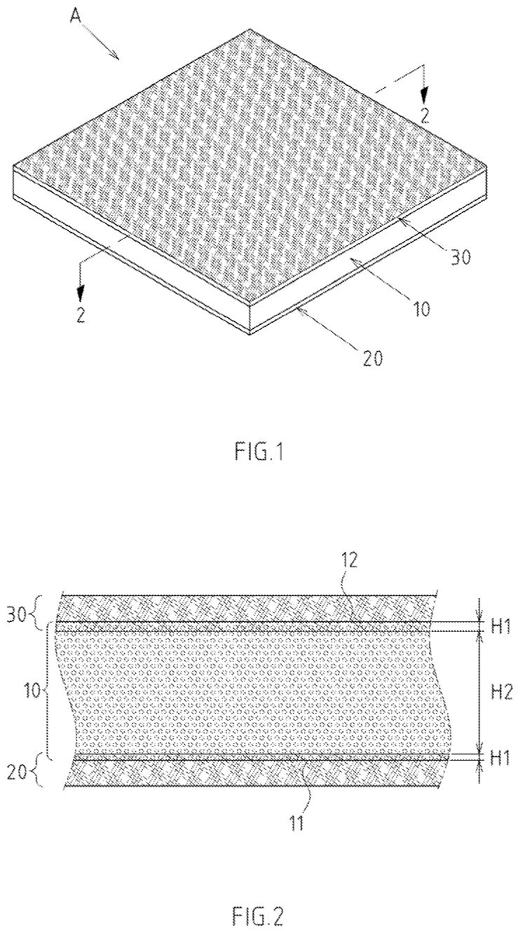

FIGS. 1 and 2 depict a preferred embodiment of a construction sound dampening pad to avoid pseudo-adhesive state according to the invention. However, such an embodiment is for illustrative purpose only, and is not intending to limit the scope of the invention.

The construction sound dampening pad A comprises the following components: a foamed layer 10, in the form of a soft and flexible pad structure made of either rubber or polymer through foaming in an appropriate proportion (note: preferred embodiment also includes compressible and ductile property), said foamed layer 10 having a thickness and having a first surface 11 and a second surface 12; a first porous fiber layer 20, being a soft, flexible, compressible, ductile, and porous layer structure containing fiber materials, said first porous fiber layer 20 being attached to the first surface 11 of the foamed layer 10; a second porous fiber layer 30, being a soft, flexible, compressible, ductile, and porous layer structure containing fiber materials, said second porous fiber layer 30 being attached to the second surface 12 of the foamed layer 10. Specifically, the first porous fiber layer 20, the second porous fiber layer 30, and the foamed layer 10 are bonded together by attaching the first porous fiber layer 20 to the first surface 11, and attaching the second porous fiber layer 30 to the second surface 12 when the foamed layer 10 is still not cooled and solidified during the process of melting and foaming, so as to form a structure wherein part of the structure of the first porous fiber layer 20 penetrates into the first surface 11, and part of the structure of the second porous fiber layer 30 penetrates into the second surface 12 to achieve a strong and reliable bonding.

Specifically, the first porous fiber layer 20 and the second porous fiber layer 30 are made of either non-woven cloth or woven cloth (note: the two can be made of different fiber materials).

Referring to FIG. 2, in this embodiment, the texture density in the depth range of the foamed layer 10 for part of the first porous fiber layer 20 and the second porous fiber layer 30 to penetrate in (the range indicated by H1) is relatively lower than the texture density in other parts of the foamed layer 10 (the range indicated by H2).

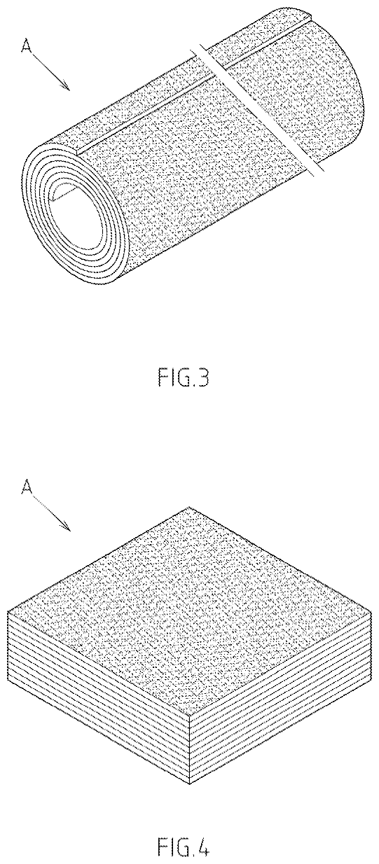

Referring to FIG. 3, in this embodiment, the construction sound dampening pad A is configured as a long sheet and is made into a roll for ready use.

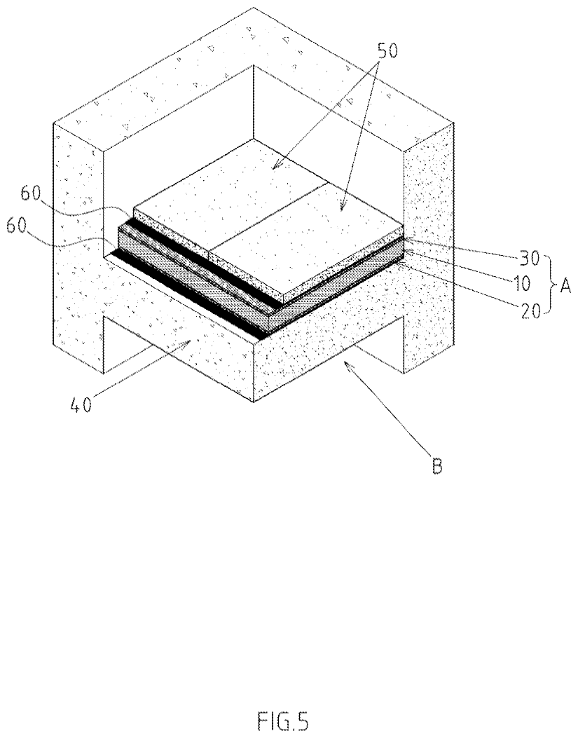

Referring to FIG. 4, in this embodiment, the construction sound dampening pad A is configured in a rectangular, (or polygonal or round) shape, and is stacked for ready use.

Referring to FIG. 5, in actual applications, the construction sound dampening pad A is bonded with a concrete layer 40 through its first porous fiber layer 20 facing downward, and bonded with floor tiles 50 through its second porous fiber layer 30 facing upward, so that the construction sound dampening pad A, the concrete layer 40, and the floor tiles 50 constitute a sound dampening floor B.

Referring to FIG. 5, in this embodiment, between the first porous fiber layer 20 and the concrete layer 40, and between the second porous fiber layer 30 and the floor tiles 50, tile gripper 60 (or other cement mortar) is used to bond them together.

Furthermore, said construction sound dampening pad A can be made of one single layer or a plurality of layers; when made of a plurality of layers, between the different layers of the construction sound dampening pad A, cement mortar is used to bond the first porous fiber layer 20 and the second porous fiber layer 30. The plurality of layers of the construction sound dampening pad A disclosed in this embodiment offers multiplied elastic buffering effect. Moreover, thanks to the property of fibers, when multiple layers are laminated together, the pad will have better friction and bonding effect. This effect cannot be achieved by directly stacking foamed pads.

Based on the aforementioned structural design and technical features, the construction sound dampening pad A disclosed in the present invention can be applied as a device to reduce noise and vibration in floor and separating wall structures. FIG. 5 depicts an embodiment of the invention used as sound dampening floor B. In this embodiment, through the innovative design that the foamed layer 10 of the construction sound dampening pad A is bonded with the first porous fiber layer 20 and the second porous fiber layer 30 on the respective sides, in actual usage, the construction sound dampening pad A can be firmly bonded with the concrete layer 40 and the floor tiles 50 by simply using tile gripper 60 or other cement mortar. The reason is that, when the tile gripper 60 or other cement mortar is solidified, it will form an interlocking state of bonding with the first porous fiber layer 20 and the second porous fiber layer 30 to form an interlocked layer structure. And between the first porous fiber layer 20, the second porous fiber layer 30 and the two sides of the foamed layer 10, the bonding is accomplished during the process of melting and foaming, featuring partial penetration and interlocking to form a physically composite layer structure (a structural bonding state). For sure, it can effectively avoid the problem of pseudo-adhesive state between the conventional rubber pad and the cement mortar layer, and enable the construction sound dampening pad A to be firmly bonded with the floor (or separating wall) structure of the construction, avoiding future separation, water penetration, bulging or deformation in the future. Moreover, the invention can solve the problem of high cost and low efficiency in the application of cement mortar layer and steel mesh, and as a result, it will greatly reduce the engineering cost of construction sound-dampening structures while enhancing work efficiency. Furthermore, through the present invention, the floor or wall structures can have less load and better reliability. It is really a practical and ideal innovative invention.

I claim:

1. A construction sound dampening pad to avoid pseudo-adhesive state, said construction sound dampening pad comprising:
a foamed layer, in the form of a soft and flexible pad structure made of either rubber or polymer through a foaming process, said foamed layer having a thickness and having a first surface and a second surface;
a first porous fiber layer, being a soft, flexible, compressible, ductile, and porous layer structure containing fiber materials, said first porous fiber layer being attached to the first surface of the foamed layer; and
a second porous fiber layer, being a soft, flexible, compressible, ductile, and porous layer structure containing fiber materials, said second porous fiber layer being attached to the second surface of the foamed layer;
specifically, the first porous fiber layer, the second porous fiber layer, and the foamed layer are bonded together by attaching the first porous fiber layer to the first surface, and attaching the second porous fiber layer to the second surface when the foamed layer is still not cooled and solidified during the process of melting and foaming, so as to form a structure wherein part of the structure of the first porous fiber layer penetrates into the first surface, and part of the structure of the second porous fiber layer penetrates into the second surface to achieve a strong and reliable bonding.

2. The construction sound dampening pad to avoid pseudo-adhesive state defined in claim 1, wherein said first porous fiber layer and said second porous fiber layer are made of either non-woven cloth or woven cloth.

3. The construction sound dampening pad to avoid pseudo-adhesive state defined in claim 1, wherein, the texture density in the depth range of the foamed layer for part of the first porous fiber layer and the second porous fiber layer to penetrate in is relatively lower than the texture density in other parts of the foamed layer.

4. The construction sound dampening pad to avoid pseudo-adhesive state defined in claim 1, wherein said construction sound dampening pad is configured as a long sheet, and is made into a roll for ready use.

5. The construction sound dampening pad to avoid pseudo-adhesive state defined in claim 1, wherein said construction sound dampening pad is configured in a rectangular, polygonal or round shape, and is stacked for ready use.

6. The construction sound dampening pad to avoid pseudo-adhesive state defined in claim 1, wherein said construction sound dampening pad is bonded with a concrete layer through its first porous fiber layer facing downward, and bonded with floor tiles through its second porous fiber layer facing upward, so that the construction sound dampening pad, the concrete layer, and the floor tiles constitute a sound dampening floor.
